(19) United States
(12) Patent Application Publication
(10) Pub. No.: US 2011/0185008 A1
(43) Pub. Date: Jul. 28, 2011

(54) Methods and Apparatus for Supporting and Implementing Multi-User Interactions Including Shared Display Devices

(76) Inventors: Phac Le Tuan, San Jose, CA (US); Sebastien Le Tuan, (US); Andras Boross, Belmont, CA (US)

(21) Appl. No.: 13/007,602

(22) Filed: Jan. 15, 2011

Related U.S. Application Data
(60) Provisional application No. 61/299,028, filed on Jan. 28, 2010.

(51) Int. Cl. G06F 15/16; G06N 5/02

(52) U.S. Cl. 709/202

(57) ABSTRACT

Methods and apparatus for implementing multi-user casual interactions between users, a plurality of shared display devices, and/or a plurality of third-party devices. The methods include the ability for any user, without any registration prerequisite, to enter content on a handset and to cause certain content changes to be displayed on certain shared display devices, as well as related content information to be sent back to the requesting user's handset and optionally to other users' handsets or to certain third-party devices. The methods also include the ability for an operator to use a graphical user interface to create and manage the rules that control such behavior depending, among other parameters, on the user's submissions or on other users' submissions over a period of time. The methods enable the rules to be extended in an unlimited fashion thanks to the ability to interconnect with a plurality of third-party services.

### RELATED APPLICATIONS

This application claims priority to provisional Application Ser. No. 61/299,028, filed Jan. 28, 2010 which is incorporated herein by reference in its entirety. The term “Crowdversation Engine” has been replaced by the term “Conversation Engine.”

### TECHNICAL FIELD

The present invention relates to providing services to groups or to organizations providing services to groups.

### BACKGROUND OF THE INVENTION

With the advent of the Internet and the mobile Internet, organizations have the need to differentiate by sending more and more information, in a plurality of forms, about products and services to users, whether they are at home, at the office, or on-the-go.

As users lead increasingly fragmented lives under constant information overload, they can only absorb new information when it is relevant to them, available at the right time and in the right form.

To address this issue of relevancy, industry efforts are primarily directed at using some piece of information provided directly or indirectly by the user to select the relevant information to present to such user in a simple isolated transaction that is not related to a prior transaction or to the next one.

For example, Google Adwords™ uses search keywords to present advertising that is relevant to the user during their current activity. The next search using a different keyword will produce different advertising content unrelated to the first search.

Waterfall Mobile™ (www.waterfallmobile.com) provides SMS-based services allowing marketers to send information about a product or service in response to a keyword sent from a mobile phone. When the same user sends a different keyword, they will get a different answer, unrelated to their first request.

Elo TouchSystems™ provides interactive digital signage systems capable of providing specific information in response to users touching a particular area on the screen, but the transaction does not automatically identify the user, resulting in the impossibility to relate one transaction to the next one with the same user. Additionally, the resulting information displayed on the touchscreen is not available in a form that the user can take away and use easily once they have walked away from the touchscreen.

As the context and the environment continuously change, organizations need to adjust their messages constantly and are often faced with limitations of existing solutions designed mainly for providing the same information to a large number of users without consideration for the real-time needs and wants of such audience. For example, digital signage systems are mainly designed to display a fixed sequence of media content during a given period of time according to fixed rules set up in advance by an operator.

To address the issue of multi-user interaction, existing multi-user collaborative solutions require participants to be invited or to sign up before they can start interacting with the group. This requirement is a hindrance for mobile users who are only casually interested in participating and do not want to go through any type of process to get started.

There is a significant challenge to providing the relevant information to any particular user depending on their expressed or implicit needs, their preferences, their individual constraints, and their historical transactions with the organization, at the right time and in the right form, while requiring users to provide only a minimum amount of personal information in each instance, and adjusting to the fact that users have different personalities and can change their minds over time.

Relevant Literature:

Hu, et al. U.S. Pat. No. 7,865,913 presents a system for collaboration between computers.
Matsuzawa , et al. U.S. Pat. No. 7,865,840 presents an information processing apparatus and mobile terminal device.
Dooley , et al. U.S. Pat. No. 7,865,831 presents a method of updating content for an automated display device.
Tuzhilin , et al. U.S. Pat. No. 7,865,546 presents a method for notification in a network
Celi, Jr. , et al. U.S. Pat. No. 7,865,436 presents a method for using images transferred from a mobile device.
Bathurst, et al. U.S. Pat. No. 7,864,937 presents a control for en electronic multi-pod conferencing system.
Kim, et al. U.S. Pat. No. 7,861,184 presents a method for displaying menu items in a mobile device.
Aleksic U.S. Pat. No. 7,861,007 presents a method for multimedia display in a mobile device
Ismail, et al. U.S. Pat. No. 7,860,937 presents a system of messaging and service for mobile computers.
Gheorghe, et al. U.S. Pat. No. 7,860,925 presents a recommendation method based on weighted values.
Ramer, et al. U.S. Pat. No. 7,860,871 presents a user history influenced search system adapted to mobile devices.
Ueno, et al. U.S. Pat. No. 7,859,483 presents an electronic conference control device and conference assistant method.
Kramer, et al. U.S. Pat. No. 7,856,360 presents a system for providing a service to venues where people aggregate based on the demographics of the attendees.
Yoon, at al. U.S. Pat. No. 7,809,786 presents an apparatus for remotely controlling household appliances.
Bearman U.S. Pat. No. 7,801,946 presents a system for accessing web services via an instant messaging client.
Schindler, et al. U.S. Pat. No. 7,800,622 presents a method for selective access of display data sequencing in mobile computing.
Shionoya, et al, U.S. Pat. No. 7,725,400 presents a method for managing viewing of a particular pre-recorded content.
Kropivny U.S. Pat. No. 7,765,266 presents a method for publishing content during a communication.
Kropivny U.S. Pat. No. 7,765,261 presents a method for supporting a multiple-party communication on a plurality of computer servers.
Pell, et al. U.S. Pat. No. 7,565,175 presents a method of mobile information services.
Shimizu U.S. Pat. No. 7,526,316 presents a method for mobile phone and mobile phone control.
Lee, et al. U.S. Pat. No. 7,366,549 presents a method for controlling external display via an integrated mobile device.
Savage, et al. U.S. Pat. No. 7,322,516 presents a method for conducting self-service transaction in a bank from a remote terminal.
Guyot, et al. U.S. Pat. No. 7,231,205 presents a method for changing graphical data by mobile devices.
Coffman, et al. U.S. Pat. No. 7,137,126 presents a system for conversational computing via a conversational virtual machine.
Smith, et al. U.S. Pat. No. 6,594,673 presents a method for visualization for collaborative information.
Bayrakeri U.S. Pat. No. 6,388,680 presents a method for multi-user extension mechanism for client-server system
Bayrakeri U.S. Pat. No. 6,185,602 presents a method for multi-user interaction of multimedia communication

### BRIEF SUMMARY OF THE INVENTION

The present invention provides a method and apparatus for creating and managing the rules that control in real-time how, when and what information content is provided to any number of users simultaneously interacting with the system by submitting in sequence one or more messages and receiving a custom response to each of their submissions.

Another aspect of the present invention is the mechanism for controlling the communications between an entity and a group of users, or between groups of users, to facilitate the creation, publishing and distribution of dynamic content in the conversation between the entity and each user, or between users among themselves.

Another aspect of the present invention is the mechanism where users can be addressed individually as well as collectively.

Another aspect of the invention is the mechanism where such conversations are being carried through the usage of a user device (such as a handset), a shared display device (such as a digital sign), and an entity-controlled device (such as a computer system).

Another aspect of the present invention is the mechanism used to direct the custom response in real-time to a shared device and/or a private device depending on certain rules and on the nature of the information contained in said custom response.

Another aspect of the present invention is the mechanism used to determine which shared device is the most relevant for each interacting user, depending on their physical location and/or the content they are submitting.

Another aspect of the present invention is the mechanism used to set up such rules and their associated actions in a graphic and visual way without requiring any programming language skills.

Another aspect of the present invention is the rule selector mechanism used to control when a rule is selected depending on the user submission and the context of the submission.

Another aspect of the present invention is the rule condition mechanism used to define which action or set of actions should be performed once a given rule has been selected.

Another aspect of the present invention is the mechanism used to associate an adaptive self-modifying agent to each of the actions triggered by the rule condition of a selected rule.

Another aspect of the present invention is the mechanism used to associate an external agent to a given action triggered by the rule condition of a selected rule.

Another aspect of the present invention is the mechanism used to set up such rules and their associated actions in a graphic and visual way without requiring any programming language skills.

Another aspect of the present invention is the mechanism used to associate an event to a selected rule to facilitate the segmentation of the population of users having interacted with the system.

Another aspect of the present invention is the mechanism used to enable the submission by an authorized user to securely, dynamically and remotely change the parameters of some rule selectors and/or rule conditions resulting in an altered, adaptive behavior of the system.

Another aspect of the present invention is the mechanism used to specify which content should be displayed publicly and which content should be displayed privately on the handset of the interacting user.

Another aspect of the present invention is the state engine mechanism used to alter the behavior of some rule selectors and/or some rule conditions depending on previous interactions by other users relative to such rules or their associated events.

Another aspect of the present invention is the mechanism used to allow users to have multiple personalities while interacting through the system with the same organization without losing the benefit of receiving a customized service.

Another aspect of the present invention is the mechanism used to manage the control of the content displayed on one public device between a plurality of users using their handsets based on a combination of rules depending on the nature of the needs of each user.

Another aspect of the present invention is the mechanism used to automate the generation of rules for the common use cases for any given market segment.

### BRIEF DESCRIPTION OF THE FIGURES

FIG. 1 is a block diagram illustrating some of the major functional components of a computer system required to produce conversational interactions between a plurality of handsets 100 and a plurality of shared display devices within a digital signage sub-system 140, including the conversation engine sub-system 120 in accordance with an aspect of the present invention.

FIG. 2 is a block diagram illustrating some of the major functional components of the conversation engine sub-system 120, including the conversation engine 124 in accordance with an aspect of the present invention.

FIG. 3 is a block diagram illustrating some of the major functional components of the digital signage sub-system 140, including one or more display devices 146 and their associated media players 144 in accordance with an aspect of the present invention.

FIG. 4 is a detailed block diagram expanded from FIG. 1 by illustrating in detail the conversation engine sub-system 120 and the digital signage sub-system 140 in accordance with an aspect of the present invention.

FIG. 5 is a diagram illustrating the data flows between users, display devices, information service providers and the conversation engine 124 in accordance with an aspect of the present invention.

FIG. 6 is a flowchart illustrating the sequence of operations involved in the conversation engine 124 upon reception of a user-generated content submission in accordance with an aspect of the present invention.

FIG. 7 is a schematic block diagram of a method to implement the various rules and agents of the conversation engine 124 in accordance with an aspect of the present invention.

FIG. 8 is a schematic block diagram of a method to implement the relationship between rules, agents and events within the conversation engine 124 in accordance with an aspect of the present invention.

FIG. 9 is a schematic block diagram of a method to implement certain features of an agent 340, such as the adaptive self-modifying function 343, and the third-party extension interface 344 in accordance with an aspect of the present invention.

FIG. 10 is a simulation of a user interface screen employed in defining the rules of the conversation engine 124 in accordance with an aspect of the present invention.

FIG. 11 is a schematic block diagram of a method to implement a user interface screen to capture the parameters of the application 500 of present invention in a given use case, and to generate the associated rules designed to effect the requirements of the application in accordance with an aspect of the present invention.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art and the general principles defined herein may be applied to other embodiments and applications without departing from the spirit and the scope of the present invention. Thus, the present invention is not intended to be limited to the embodiments shown, but is to be accorded the widest scope consistent with the principles and features disclosed herein.

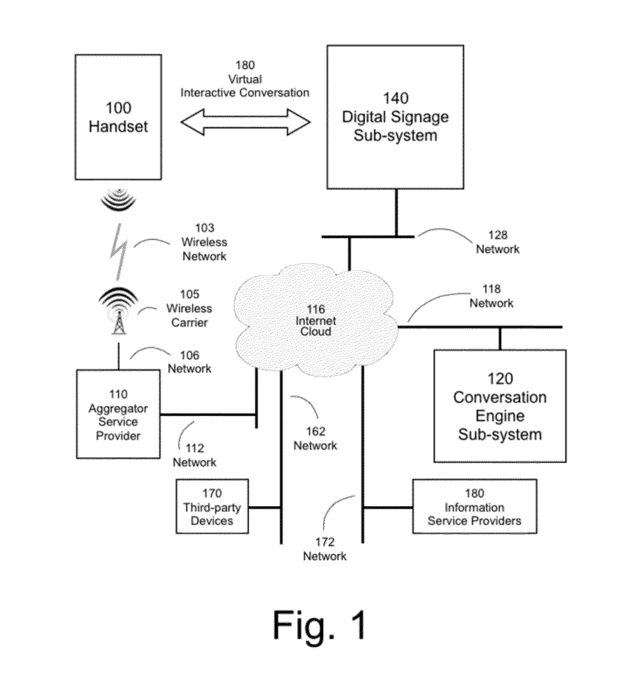

FIG. 1 is a block diagram illustrating a computer system including resources to produce conversational interactions between a plurality of handsets 100 and a plurality of shared display devices within a digital signage subsystem 140 in accordance with an aspect of the present invention. FIG. 1 includes handset 100, wireless carrier 105, aggregator 110, conversation engine sub-system 120, digital signage sub-system 140, third-party devices 170, and information service providers 180, which are interconnected through distinct networks 103, 106, 112, 116, 118, 128, 162, and 172.

A subject using handset 100 enters content in the form of text or multimedia (picture, graphic, sound, or video) or computer file and sends the content through the wireless network 103 to their wireless carrier 105. The wireless carrier 105 receives the content and forwards it through the network 106 to the aggregator service provider 110, who forwards it to the conversation engine sub-system 120 through the succession of networks 112, 116 and 118.

The conversation engine sub-system 120 receives the content and processes it, optionally connecting with each of the external information service providers 180 through the networks 118, 116 and 172, the network 172 being distinct for each of the information service providers 180.

The conversation engine sub-system 120 prepares the content targeted to the handset 100, the digital signage sub-system 140, the third-party devices 170, and sends each prepared content to its respective targeted destination.

The content targeted to the handset 100 is sent through the networks 118, 116, and 112 to the aggregator service provider 110 who forwards the content through the network 106 to the wireless carrier 105 who forwards the content through the wireless network 103 to the handset 100.

The content targeted to the digital signage sub-system 140 is sent through the networks 118, 116, 128.

The content targeted to each of the third-party devices 170 is sent through the networks 118, 116, and 162, the network 162 being distinct for each of the third-party devices 170, and can be either a wireline or a wireless network or a hybrid combination thereof.

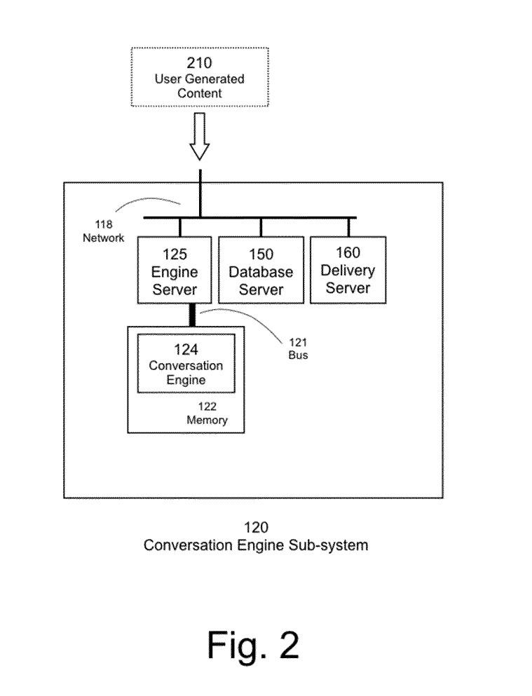

FIG. 2 is a block diagram illustrating some of the major functional components of the conversation engine sub-system 120, including the engine server 125, the database server 150 and the delivery server 160, in accordance with an aspect of the present invention.

The engine server 125 includes the conversation engine 124 in the memory 122. The engine server 125 accesses the scenario data stored in the database server 150 to feed the conversation engine 124 which processes each user generated content 210 and stores transactional data back into the database server 150.

The content stored in the database server 150, or by an information service provider 180, or generated by the engine server 125, is prepared by the conversation engine 124 according to the selected rules and sent through the delivery server 160 to each of its intended recipients, the handset 100, the digital signage subsystem 140, or the third-party devices 170, as represented in FIG. 1.

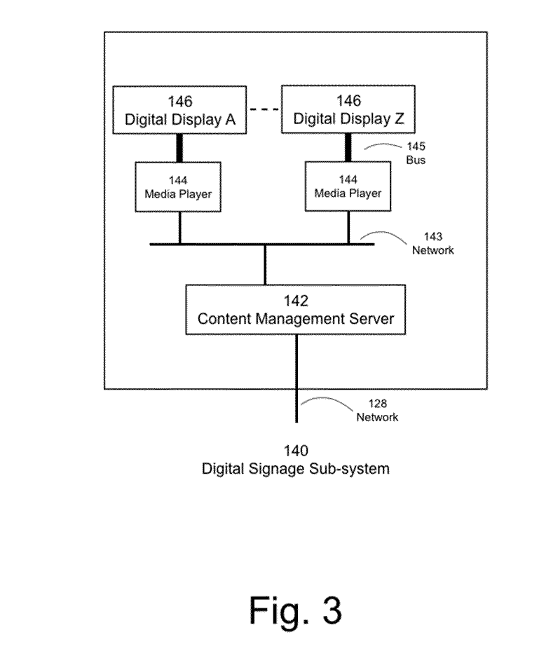

FIG. 3 is a block diagram illustrating some of the major functional components of the digital signage sub-system 140, including the content management server 142, one or more media players 144, and one or more digital display devices 146, the media players 144 being connected to the content management server through the network 143, and the media players 144 being each connected to one or more display device 146 through the bus 145, in accordance with an aspect of the present invention.

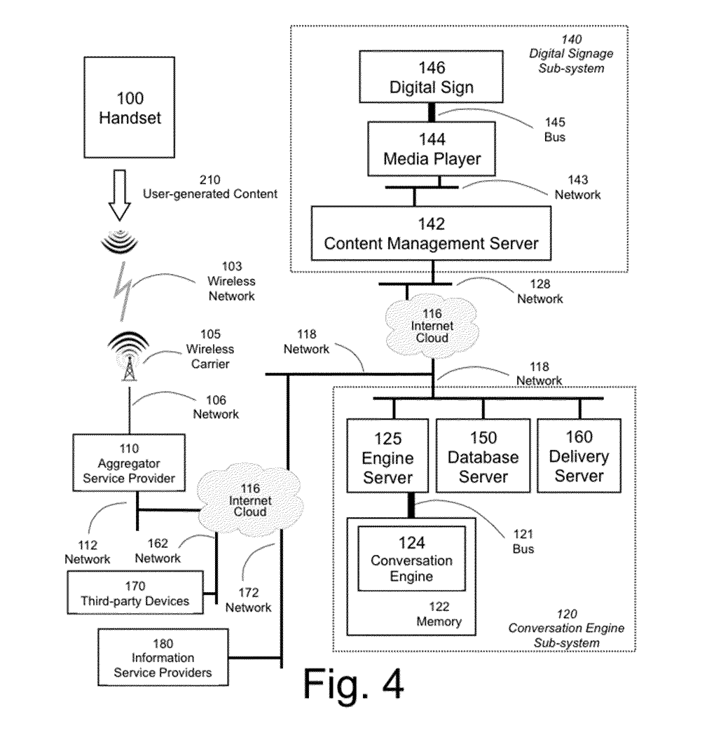

FIG. 4 is an expansion of FIG. 1 and a detailed block diagram illustrating a computer system including resources to produce conversational interactions between a plurality of handsets 100 and a plurality of shared display devices within a digital signage subsystem 140 in accordance with an aspect of the present invention. FIG. 4 includes handset 100, wireless carrier 105, aggregator 110, engine server 125, conversation engine 124, content management server 142, media player 144, display device 146, database server 150, and delivery server 160, which are interconnected through distinct networks 103, 106, 112, 116, 118, 128, 143, 162 and 172, and bus 121 and 145.

A subject using handset 100 enters user generated content 210 in the form of text or multimedia (picture, graphic, sound, video) or computer file and sends the content through the wireless network 103 to their wireless carrier 105. The wireless carrier 105 receives the content and forwards it through the network 106 to the aggregator service provider 110, who forwards it to the engine server 125 through the succession of networks 112, 116 and 118.

The engine server 125 receives the content 210 and processes it in the conversation engine 124 located in memory 122. The engine server 125 accesses the scenario data stored in the database server 150 to feed the conversation engine 124 which processes the content 210 and stores transactional data back into the database server 150 through the network 118, and with each of the external information service providers 180 through the networks 118, 116 and 172, the network 172 being distinct for each of the information service providers 180.

The content stored in the database server 150, or by an information service provider 180, or generated by the engine server 125, is prepared by the conversation engine 124 according to the selected rules and sent through the delivery server 160 to each of its intended recipients, the handset 100, the content management server 142, the third-party devices 170. The delivery server 160 determines the most appropriate mechanism to send each prepared content to its targeted destination.

The content targeted to the handset 100 is sent through the networks 118, 116, and 112 to the aggregator service provider 110 who forwards the content through the network 106 to the wireless carrier 105 who forwards the content through the wireless network 103 to the handset 100.

The content targeted to the appropriate display device 146 is sent through the networks 118, 116, 128 to the Content Management Server 142, which processes and forwards it through the network 143 to the media player 144, which sends the processed content to the display device 146.

The content targeted to each of the third-party devices 170 is sent through the networks 118, 116, and 162, the network 162 being distinct for each of the third-party devices 170.

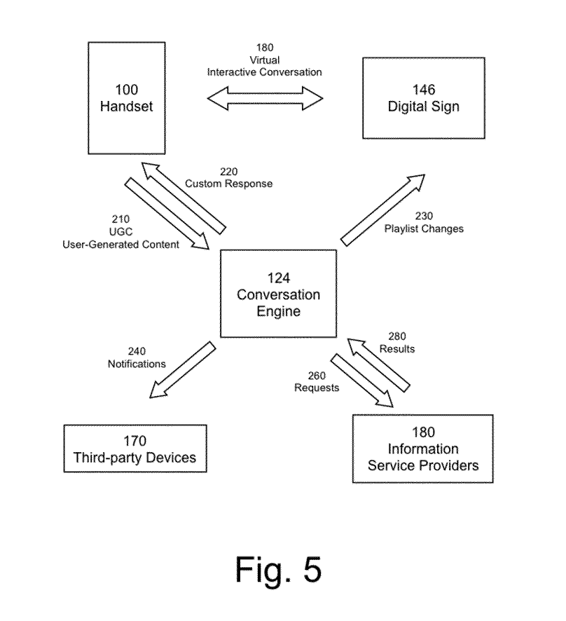

FIG. 5 is a diagram illustrating the data flows between a user using the handset 100 in an interactive conversation with a display device 146 in accordance with an aspect of the present invention.

The diagram includes the handset 100, third-party users using a device 170, a display device 146, information service providers 180 and the conversation engine 124.

A subject using the handset 100 submits user-generated content 210 to the conversation engine 124 and receives in return a custom response 220. At the same time, and depending on the submitted content 210, the conversation engine could send playlist changes 230 forcing the display device 146 to display some content more relevant to the interacting user.

Depending on the selected rules triggered by the submitted content 210, the conversation engine 124 sends notifications 240 to third-party devices. The conversation engine can also send requests 260 to third-party information service providers who send in response results 280 that are automatically processed by the conversation engine to alter the behavior of some rules, or the content ultimately sent to the handset 100, the display device 146 or third-party devices 170.

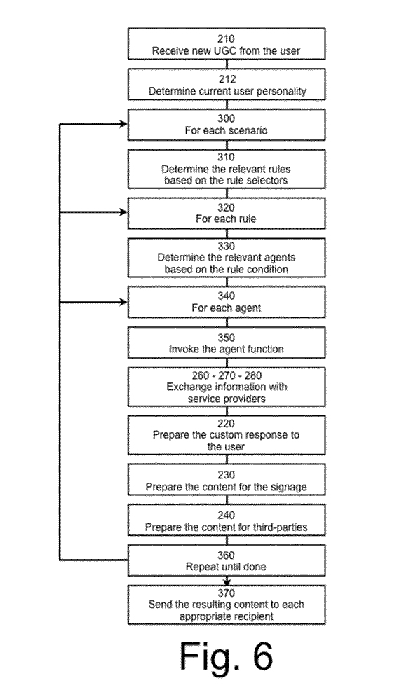

FIG. 6 is a flowchart illustrating the sequence of operations involved in processing a user-generated content 210 submission in accordance with an aspect of the present invention.

Upon reception of a user-generated content 210, the system determines the most relevant user personality 212 based on: a) a handset identifier associated with the handset 100 used to send the user-generated content 210; b) the current state machine associated with said handset identifier; c) the potential event 400 associated with each agent 340 to be invoked later in the sequence of operations.

The conversation engine uses the rule selectors 310 to select the relevant rules and using the rule conditions 330 of the selected rules to select the agents 340 to invoke in order to complete the processing of the user-generated content 210 by the conversation engine 124.

The custom response 220 sent back to the interacting user is an aggregate of the custom responses prepared by each invoked agent 340. Similarly, the content 230 displayed on the display device 146 is a combination of the contribution of one or more invoked agents 340. The content 240 sent to the third party devices 170 is also a combination of the content prepared by one or more agents 340.

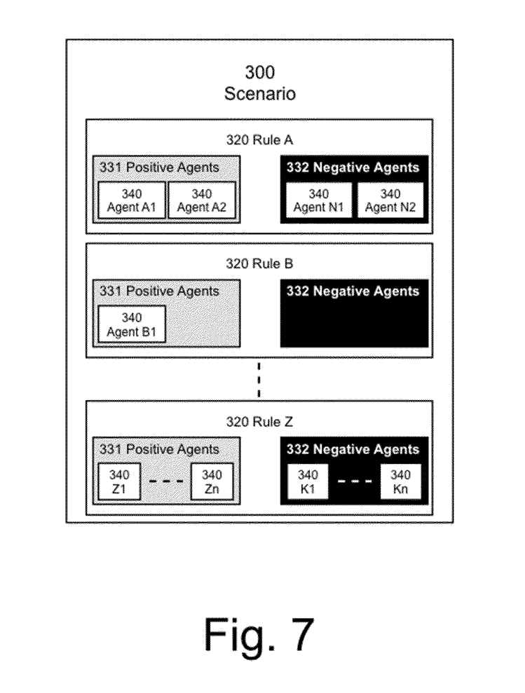

FIG. 7 is a schematic block diagram of a method to implement the various modules of the conversation engine 124 in accordance with an aspect of the present invention.

The conversation engine 124 processes the user-generated content 210 according to one or more scenarios 300. Each scenario 300 is composed of one or more Rules 320 to be processed in a sequence that can be altered when invoking certain agents 340.

Each Rule 320 is composed of two sets of agents, the positive agents 331 and the negative agents 332. The positive agents 331 are invoked if the rule condition 330 is met at run-time, while the negative agents 332 are invoked if the rule condition 330 is not met at run-time.

Each set of agents 331 and 332 can contain zero or more agents 340.

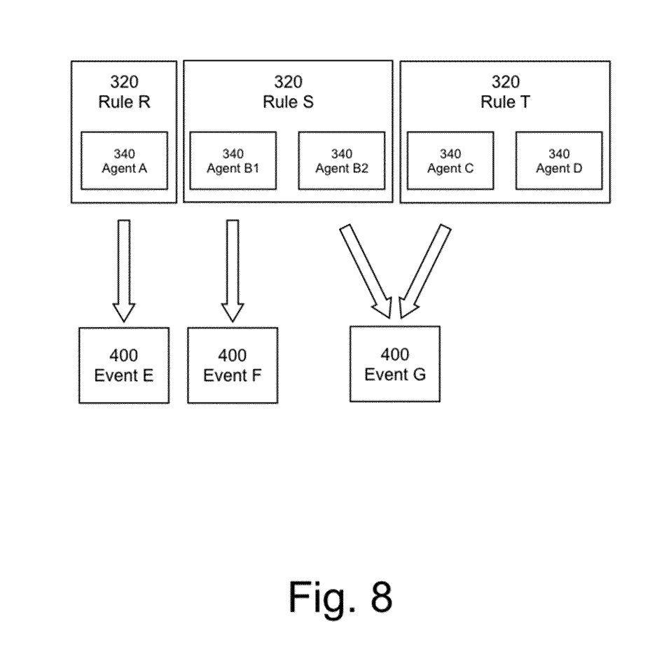

FIG. 8 is a schematic block diagram of a method to implement the relationship between rules, agents and events within the conversation engine 124 in accordance with an aspect of the present invention.

Each agent 340 can be associated with zero or one event 400 at most. Agents 340 from different rules 320 can be associated to the same event 400, and agents within one rule 320 can be associated with different events 400.

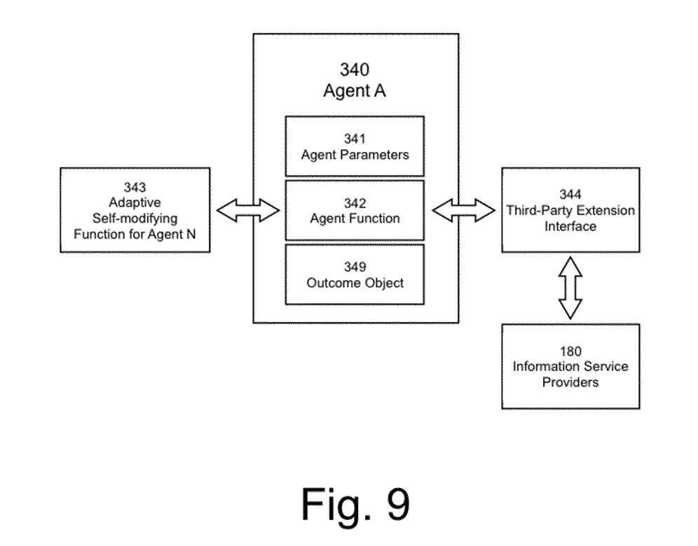

FIG. 9 is a schematic block diagram of a method to implement certain features of an agent 340 , such as the adaptive self-modifying function 343, and the third-party extension interface 344 in accordance with an aspect of the present invention.

The adaptive self-modifying function 343 can be applied to any agent 340, including the invoking agent, and is capable of modifying the agent parameters 341 and/or the agent function 342 at run time, thereby changing the behavior of the conversation engine 124 in unpredictable albeit deterministic ways.

The adaptive self-modifying function 343 can also generate automatically a new set of rules 320 based on the submitted content, thereby extending the behavior of the conversation engine for all subsequent submissions.

The third-party extension interface 344 issues a web service request to one or more information service providers 180 built by the agent function 342 from the run time values of the agent parameters 341. The resulting responses received from the information service providers 180 are then returned in aggregate to the agent function 342 for formatting and integration within the outcome object 349.

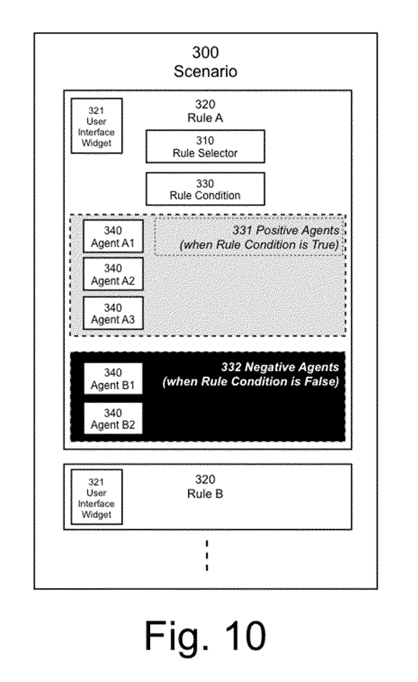

FIG. 10 is a simulation of a user interface screen employed in defining the rules of the conversation engine 124 in accordance with an aspect of the present invention.

Each rule 320 is composed of a rule selector 310, a rule condition 330, a set of positive agents 331 and a set of negative agents 332. In order to hide complexity, the components of a rule 320 should be hidden until a user interface widget 321 is triggered.

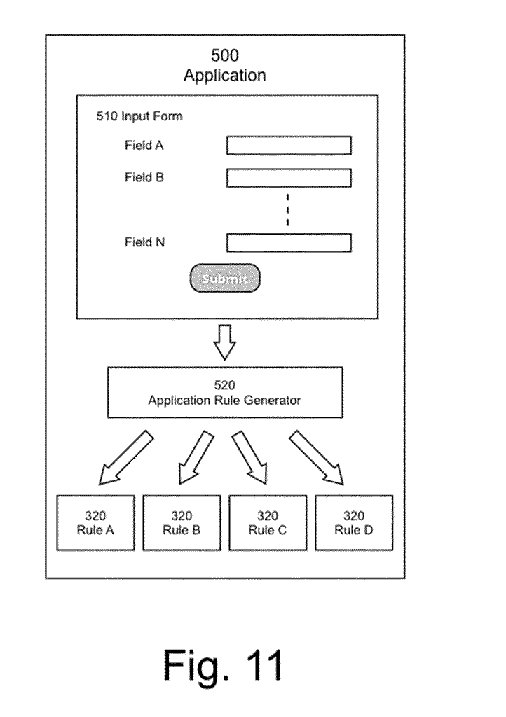

FIG. 11 is a schematic block diagram of a method to implement a user interface screen to capture the parameters of the application 500 of present invention in a given use case, and to generate the associated rules designed to effect the requirements of the application in accordance with an aspect of the present invention.

In an application of the present invention, a plurality of parameter values are defined in an input form. Upon submission of the parameters, a new set of rules 320 is automatically generated and inserted within the current active scenario. The corresponding rules 320 can then be modified directly by accessing the individual agents 340 within the rules.

The foregoing description includes examples of the present invention. It is naturally not possible to describe every conceivable combination of modules, components or methods for purposes of describing the present invention. However, one of ordinary skill in the art may easily recognize that many further combinations and permutations of the present invention are fully possible. Accordingly, the present invention is intended to embrace all such combinations, alterations, modifications and variations that fall within the spirit and scope of the appended claims. Furthermore, to the extent that the term “including” is used in either the detailed description or the claims, such term is intended to be inclusive in a manner similar to the term “comprising,” as comprising is used as a transitional word in a claim.

### EXAMPLES

In an embodiment of the present invention, customers in a fast food restaurant can inspect the menu choices on a large display device, send a request to display the daily specials on the sign and the nutritional facts on their handset. Users can also order their desired meal by entering a code on their handset, which will update an event list in the kitchen to trigger the preparation of the meal. When a meal is ready, an operator checks a box on a screen triggering another rule that sends a notification to the handset of the customer who ordered the meal.

In an alternative embodiment, a shopper in an appliance store can request a public display device to play a video explaining how to use a given appliance they are interested in. During the playback of the video, additional instructions appear on the screen enabling the shopper to download more detailed information about the product. Using a third-party application on their handset, the shopper might be able to find the same item at a better price in a store nearby. The display device can also display a call to action encouraging such shoppers to copy the information about the competing store and their publicized price, and submit such information from their handset to the store. In return, the shopper receives a custom response, including, for example, a time-limited discount coupon matching the competitor's price, for immediate purchase.

The shopper can also send another message, or use a qualified third-party mobile application, to trigger another rule using an agent that will notify a third-party social network service provider of the special discount they just got.

In another embodiment, a patient in a doctor's waiting room can read from the flat screen TV instructions on how to get more detailed information about a procedure they are considering, and have the corresponding tutorial video either displayed on the TV or more privately downloaded onto their handset. Instructions on the TV can also enable patients or their parents to request notifications prior to the next scheduled appointments, for example to have dental braces checked.

In another embodiment, participants in a group brainstorming session within a corporate business seminar or workshop can contribute to a group think process by submitting ideas, asking or answering questions using their mobile phones, with the aggregate list of ideas, questions, or answers displayed on a shared digital screen, followed by the ability to interact with the content by voting on the submissions for example.

In another embodiment, participants in such a group brainstorming session can use their mobile phones to contribute ideas tagged as anchors or boosters attached to a virtual sailboat displayed on the shared screen, thereby collectively controlling the speed of the boat with their submissions, gaining insights about the consequences of each individual contribution on the aggregate system or collective goals.

In another embodiment, subscribers on the go can use simple feature phones to check the local TV program, to access the local schedule for their favorite TV shows, to search for the schedule of a particular type of entertainment, or to control a remote DVR to record a show they do not want to miss. Based on their current geographical location, they can be presented with the locally-available channels. Alternatively the user can enter a ZIP code to get the corresponding local channel list.

In another embodiment, real-estate agents can enter any listed home for sale to show them to prospective buyers. Upon approaching a listed home, the agent texts the house PIN from their registered mobile phone. After credential verification, the conversation engine sends an “unlock” command to the electronic door lock to let the agent into the house. The system identifies the agent by the mobile phone used during the process and keeps a traceable record of all visits to the home.

In another embodiment, a parking garage owner can set up a payment system without any digital infrastructure investment. A large poster at the entrance explains how to request an available parking space by texting a simple keyword followed by the car's license plate number. The system returns the location of an available parking space with a clickable link to a directions map. The driver completes the up-front payment with their mobile phone and is required to check out upon leaving the space to release their liability. A reminder message is sent to the driver shortly before the expiration deadline, enabling the driver to submit additional payment as appropriate. The parking attendant is notified when a car exceeds their paid allocated time.

### INDUSTRIAL APPLICABILITY

The present invention applies industrially to environments with public or private signage designed to enable venues and organizations to provide information or services to, and/or capture submissions, contributions or feedback from, visitors, participants or passers-by. More particularly, the present invention applies industrially to market such as, but not limited to, hospitality, retail, healthcare, education, transportation, entertainment, corporate workshops, and more.

In another alternative industrial application, the present invention can be applied to machine-to-machine communications whereby the handsets are replaced, in totality or partially, by machines capable of exchanging messages with the conversation engine through a wireline or a wireless connection ultimately with an access to a communication network such as the Internet.

What is claimed is:

1. A network-based computer system for managing conversations between groups, the computer system comprising: a handset, the handset including a mechanism for entering and sending digital content, in the form of text or multimedia content; a wireless network, the wireless network including a plurality of service providers and a plurality of aggregators; a server, the server including a conversation engine, the conversation engine including a data structure for representing a plurality of rules, a rule selector mechanism to select in real-time a plurality of rules, each rule including a set of rule conditions controlling a plurality of agents and/or adaptive self-modifying agents, each agent optionally associated with an event object, each event object capable of storing the associated context, each agent including functions to modify some parameters affecting later instances of operation of rules and agents, to exchange information with a plurality of external information service providers, to prepare a custom response to send to the initial handset, to prepare content instructions for the relevant shared display devices within a digital signage system, and to prepare notifications to a plurality of third-party devices; a database server, the database server including a mechanism to store and manage data structures; a digital signage system, the digital signage system including a plurality of content management servers, a plurality of media players and a plurality of display devices, the content management server including a mechanism to manage a list of multimedia content, the multimedia content being stored either on the media player or elsewhere on the network, the media player including a mechanism to convert the multimedia content for display on the display device; a plurality of delivery servers, the delivery server including a mechanism to send content to a plurality of devices.

2. The computer system of claim 1, wherein the conversation is a succession of digital content exchanged between a handset, a plurality of display devices, a plurality of other handsets, and/or a plurality of servers.

3. The computer system of claim 1, wherein the handset is any device with communication capabilities.

4. The computer system of claim 1, wherein the display device is any digital display device that can be shared between a plurality of users.

5. The computer system of claim 1, wherein the third-party device is a handset, the handset being any device with communication capabilities.

6. The computer system of claim 1, wherein the rule selector is based on the content submitted from one or a plurality of handsets, each handset defined as in claim 4.

7. The computer system of claim 1, wherein the rule selector is based on the geographical location of one or a plurality of handsets, each handset defined as in claim 4.

8. The computer system of claim 1, wherein the rule selector is based on the geographical location of one or a plurality of display devices, each display device defined as in claim 5.

9. The computer system of claim 1, wherein the rule selector is based on a natural language recognition process that extracts semantic information from the submitted content.

10. The computer system of claim 1, wherein the rule selector is based on current date time information.

11. The computer system of claim 1, wherein the rule selector is based on a prior submission of content from one or a plurality of handsets, each handset defined as in claim 4.

12. The computer system of claim 1, wherein the rule selector is based on the selection of prior rules within the same conversation sequence.

13. The computer system of claim 1, wherein the rule selector is based on the outcome of invoking an agent associated with one of the rules of the conversation engine.

14. The computer system of claim 1, wherein the rule condition is based on any combination of the same parameters as used by the rule selector in claims 7 to 11.

15. The computer system of claim 1, wherein the operation of the agent is based on any combination of the same parameters as used by the rule selector in claims 7 to 11.

16. The method of claim 15, further comprising a mechanism to process the outcome of a real-time request exchanged with an external third-party service.

17. The method of claim 15, further comprising a mechanism to modify the parameters used by the rule selectors, rule conditions, or agents in later instances of conversations with one or a plurality of users.

18. The method of claim 15, further comprising a mechanism to enable a selected agent to generate an additional new set of rules in order to extend the behavior of the system for all subsequent content submissions.

19. The method of claim 15, further comprising a mechanism to enable a selected agent to record the current context of a content submission in a unique transaction optionally associated with an event object.

20. The method of claim 19, further comprising a mechanism to display a real-time representation of the relevant transactions on a display device, the display device defined as in claim 5.

21. The method of claim 20, further comprising a mechanism to represent in real-time the operational status of each relevant transaction, whenever it occurs.

22. The method of claim 20, further comprising a mechanism to interact with the display device to issue commands that modify the operational status of certain transactions represented on the display device.

23. The method of claim 22, further comprising a mechanism to use a handset to exchange interactive conversations with the display device in a recursive application of the conversation engine.

24. The method of claim 23, further comprising a mechanism to submit derived content on behalf of the handset associated with a given transaction in order to initiate the selection of a new sequence of rules and subsequent associated agents.

25. The computer system of claim 1, wherein the custom response includes a mechanism to aggregate the responses generated by one agent or a plurality of agents invoked by the submitted content.

26. The method of claim 25, further comprising a mechanism to download a computer application to one or a plurality of handsets, each handset defined as in claim 4.

27. The method of claim 25, further comprising a mechanism to download a custom content uniquely generated for each of a plurality of handsets, each handset defined as in claim 4.

28. The method of claim 25, further comprising a mechanism to actuate a particular function in one or a plurality of handsets, each handset defined as in claim 4.

29. The computer system of claim 1, wherein the content instructions include a call-to-action to provide the user with a plurality of available choices to control the content to be displayed on the display device, the display device defined as in claim 5.

30. The method of claim 29, further comprising a mechanism to manage a waiting list of users who want to control the content to be displayed on the display device.

31. The computer system of claim 1, wherein the relevant display device is determined by the location of one or a plurality of handsets.

32. The computer system of claim 1, wherein the relevant display device is determined by the content submitted by the user.

33. The computer system of claim 1, wherein the relevant display device is determined by a location-based service associated with one or a plurality of handsets.

34. The computer system of claim 1, wherein the relevant display device is determined by the context of recent submissions sent from one or a plurality of handsets.
